(19) United States
(12) Patent Application Publication
(10) Pub. No.: US 2014/0301068 A1
(43) Pub. Date: Oct. 9, 2014

(54) EASILY ASSEMBLED LED TUBE LAMP STRUCTURE

(71) Applicant: TONG HONG INVESTMENT CO., LTD., Taipei City (TW)

(72) Inventor: Tan Chih Wu, Taipei City (TW)

(73) Assignee: TONG HONG INVESTMENT CO., LTD., Taipei City (TW)

(21) Appl. No.: 13/859,199

(22) Filed: Apr. 9, 2013

(51) Int. Cl. F21V 3/00

(52) U.S. Cl. CPC F21V 3/005
USPC 362/218

(57) ABSTRACT

An LED tube lamp structure includes a heat-transferring and light-pervious glass tube; a slightly curved elongated heat-dissipation metal base internally bonded to the glass tube via a thermal adhesive; an LED chip circuit board fitted to a front side of the heat-dissipation metal base; and two electrode covers fitted on two open ends of the glass tube and respectively having a fixing dummy pin and a through hole. The heat-dissipation metal base has two end portions inserted into insertion sections in the electrode covers to generate an upward tension for tightly contacting with the glass tube; and the LED chip circuit board has two contact pins at two ends for extending through the through holes. Thus, the LED tube lamp can be easily assembled and provides good heat transfer and dissipation to ensure normal operation and extended service life thereof.

### FIELD OF THE INVENTION

The present invention relates to an easily assembled LED tube lamp structure, and more particularly to an LED tube lamp structure that has two electrode covers respectively externally provided with a dummy pin and a through hole, and an LED chip circuit board provided at two ends with two contact pins for projecting from the through holes without the need of welding to the electrode covers, so that the LED tube lamp can be manufactured with simplified process to achieve increased yields.

### BACKGROUND OF THE INVENTION

Currently, fluorescent lamps are requisite lighting means in people's daily life. However, thanks to the constant development in various technical fields, light-emitting diodes (LEDs) have been developed as new generation of lighting means. LEDs have many advantages, such as high brightness, fast response time, small volume, low power consumption, energy-saving, safe for use, and long service life. Therefore, LED lamps have been widely used in many applications to replace the conventional fluorescent lamps.

However, for a high-power LED lamp, only 15-20% of the input power thereof is converted into light while the other 80-85% of the input power is converted into heat. The produced heat must be timely removed from the LED lamp, lest LED chips in the LED lamp should have an excessively high interface temperature to result in reduced lighting efficiency and shortened service life of the LED lamp. Thus, good heat dissipation forms an important and critical factor in the quality of many LED lighting products.

Most of the conventional LED tube lamp structures include a lamp shell formed of an elongated aluminum extrusion strip having a semi-circular cross section, and a lamp shade formed of a plastic or acrylic material having a semi-circular cross section corresponding to the lamp shell. To overcome disadvantages of these conventional LED tube lamp structures, particularly the manufacturing process thereof, Taiwan Patent Publication No. M441792, filed by the same applicant, discloses an LED tube lamp structure that includes a heat-transferring and light-pervious glass tube and an elongated heat-dissipation metal base having a curved back side attached to an inner surface of the glass tube via a thermal adhesive, so that the heat-dissipation metal base is tightly adhered to the inner surface of the glass tube without becoming dropped, deformed or separated from the glass tube even when the LED tube lamp is lightened and produces heat. This is because the heat-dissipation metal base is in tight contact with the inner surface of the glass tube, allowing the heat produced by the LED tube lamp to be effectively transferred from the heat-dissipation metal base to the whole glass tube and be uniformly dissipated from the glass tube into ambient air. In this manner, LEDs in the LED tube lamp can maintain normal operation and can have effectively extended service life.

While the LED tube lamp structure disclosed in Taiwan Patent Publication No. M441792 is structurally and functionally excellent, it involves in relatively complicated manufacturing procedures. That is, additional wiring and welding are needed when assembling an LED chip circuit board inside the glass tube to two electrode covers of the LED tube lamp, which inevitably lowers the production efficiency and the yields of the LED tube lamp. In addition, the LED tube lamp structure disclosed in Taiwan Patent Publication No. M441792 includes an LED driving circuit that is arranged inside one of the two electrode covers of the LED tube lamp, necessitating the electrode covers to have an extended length, which adversely reduces the LED tube lamp's effective illumination length. It is therefore necessary to eliminate these disadvantages.

### SUMMARY OF THE INVENTION

A primary object of the present invention is to provide an easily assembled LED tube lamp structure to overcome the drawbacks in the conventional LED tube lamp structure.

To achieve the above and other objects, the easily assembled LED tube lamp structure according to the present invention includes a heat-transferring and light-pervious glass tube; an elongated heat-dissipation metal base having a curved back side attached to an inner surface of the glass tube via a thermal adhesive; an LED chip circuit board fitted in a receiving seat formed on a front side of the heat-dissipation metal base and being provided at each of two opposite ends with a substantially axially outward extended contact pin; and two electrode covers fitted on two open ends of the glass tube and being respectively externally provided with a fixing dummy pin and a through hole and internally provided with an insertion section. The contact pins on the two ends of the LED chip circuit board are outward extended through the two through holes of the electrode covers, and the heat-dissipation metal base has two end portions inserted into the two insertion sections to thereby be fixedly held in place between the two electrode covers and generate an upward tension.

With the above arrangements, the LED tube lamp can be manufactured with simplified procedures to obtain increased yields, and the heat-dissipation metal base is tightly attached to the inner surface of the glass tube without becoming dropped, deformed or separated from the glass tube when the LED tube lamp is lightened and produces heat. Therefore, the heat produced by the LED tube lamp is effectively transferred from the heat-dissipation metal base to the glass tube and uniformly dissipated into ambient air, allowing the LED tube lamp to work normally and have extended service life.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein

FIG. 1 is an exploded perspective view of an easily assembled LED tube lamp structure according to a preferred embodiment of the present invention;

FIG. 2 shows the arrangement of a heat-dissipation metal base in a glass tube for the easily assembled LED tube lamp structure according to the preferred embodiment of the present invention;

FIG. 3 is an assembled sectional side view of the easily assembled LED tube lamp structure according to the preferred embodiment of the present invention;

FIG. 4 is an assembled perspective view of the easily assembled LED tube lamp structure according to the preferred embodiment of the present invention; and

FIG. 5 is a cross-sectional view taken along line A-A of FIG. 4.

### DETAILED DESCRIPTION OF THE PREFERRED EMBODIMENTS

The present invention will now be described with a preferred embodiment thereof and with reference to the accompanying drawings.

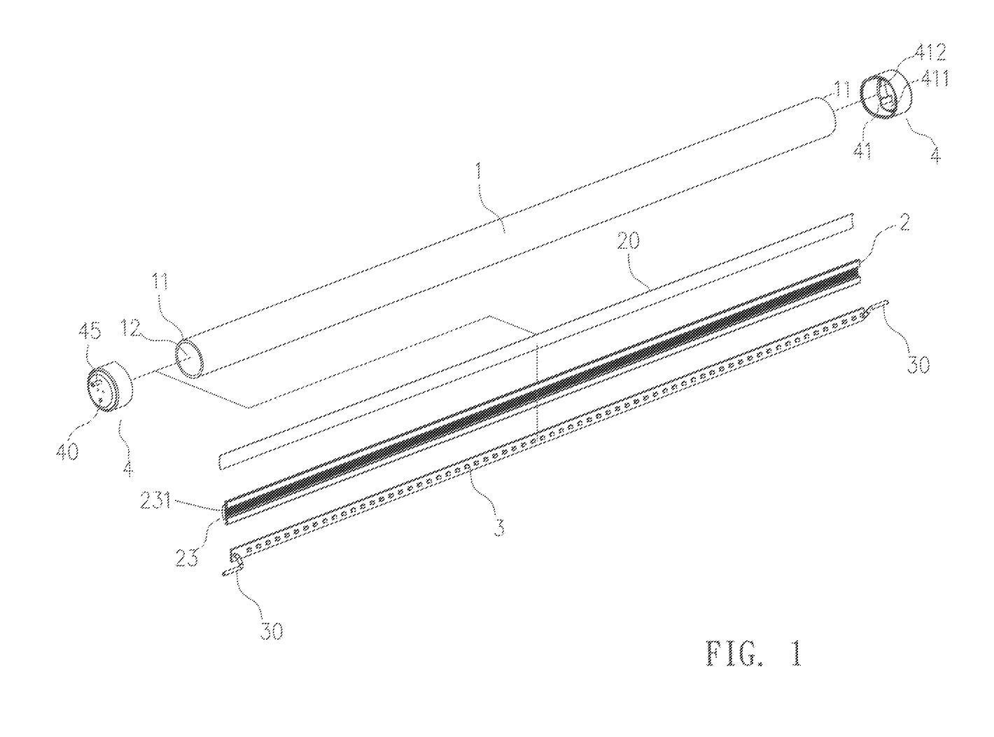

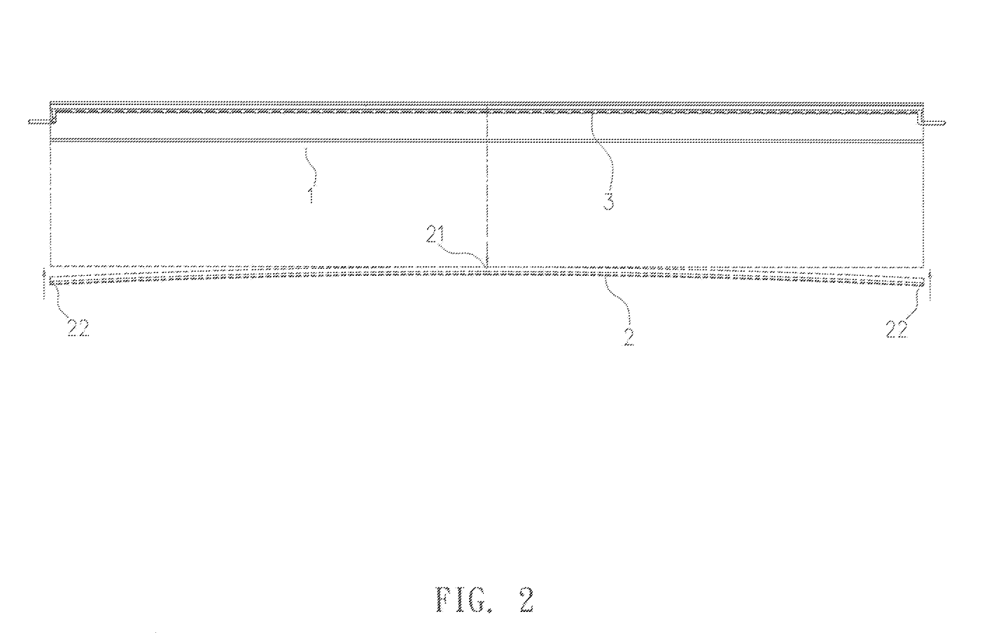

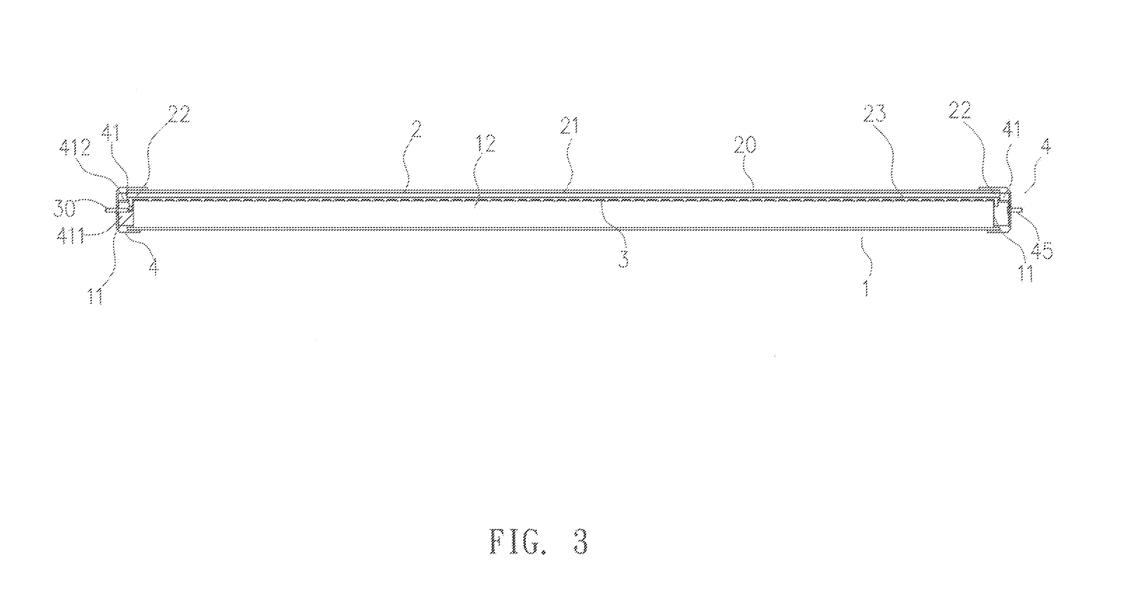

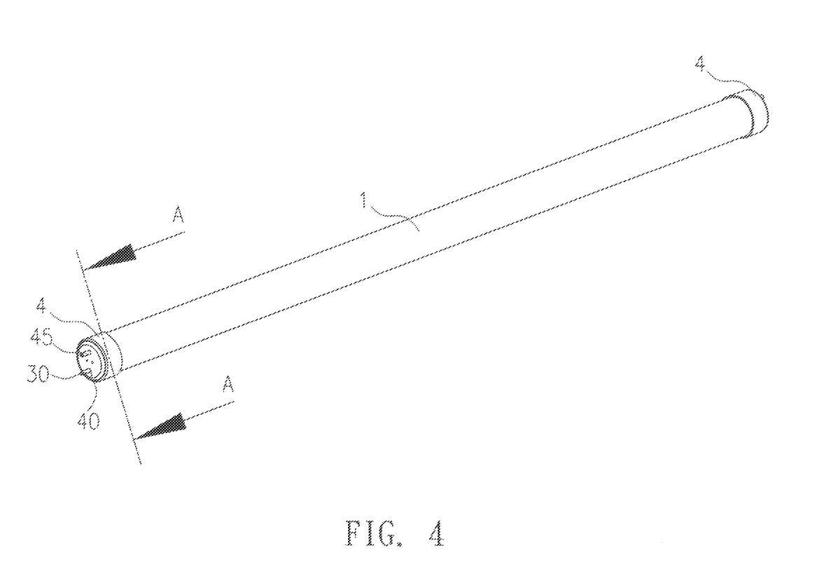

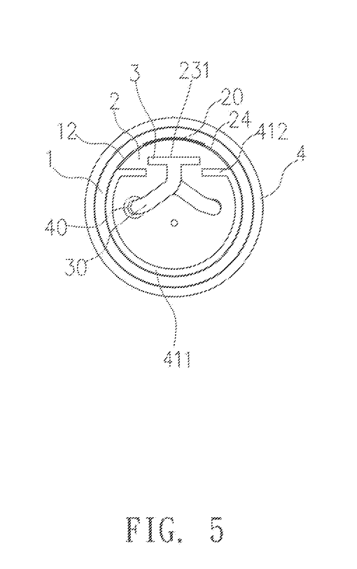

Please refer to FIGS. 1 to 5. An easily assembled LED tube lamp structure according to a preferred embodiment of the present invention includes a glass tube 1, a heat-dissipation metal base 2, an LED chip circuit board 3, and two electrode covers 4.

The glass tube 1 is a heat-transferring and light-pervious hollow cylindrical member having two open ends 11.

The heat-dissipation metal base 2 is an elongated strip having a slightly arched middle portion 21 located between two end portions 22, and therefore shows a certain degree of curvature. The heat-dissipation metal base 2 includes a front side forming a receiving seat 23, a rear side for binding to an inner surface 12 of the glass tube 1 via a thermal adhesive 20. In practical implementation of the present invention, the heat-dissipation metal base 2 can be an elongated aluminum extrusion strip having a substantially arcuate cross section. That is, the rear side of the heat-dissipation metal base 2 has a slightly tensioned arched back 24. On the other hand, the receiving seat 23 on the front side of the heat-dissipation metal base 2 is in the form of an inward recessed channel 231.

The LED chip circuit board 3 is fitted in the inward recessed channel 231 of the receiving seat 23 on the front side of the heat-dissipation metal base 2, and is provided at each of two opposite ends with a substantially axially outward projected contact pin 30. When the LED tube lamp structure of the present invention is in a fully assembled state, the two contact pins 30 are exposed from the two electrode covers 4 for plugging into two sockets to electrically connect to an externally arranged LED driving circuit (not shown).

The two electrode covers 4 are fitted on the two open ends 11 of the glass tube 1, and are respectively externally provided with a fixing dummy pin 45 and a through hole 40 and internally provided with an insertion section 41. The contact pins 30 on the two ends of the LED chip circuit board 3 are outward extended through the two through holes 40 of the electrode covers 4. The electrode covers 4 are configured as two caps respectively defining an internal space, in which there is provided an open-topped round bracket 411 that has two facing ends formed into two horizontal wing portions 412. The open-topped round bracket 411 together with the two horizontal wing portions 412 constitutes the insertion section 41. The two end portions 22 of the heat-dissipation metal base 2 are inserted into the electrode covers 4 to engage with the insertion sections 41, so that the heat-dissipation metal base 2 is held in place between the two electrode covers while generating an upward tension.

As can be seen in FIGS. 1 to 5, the easily assembled LED tube lamp structure according to the present invention includes an LED chip circuit board 3 that has two ends respectively provided with an outward projected contact pin 30, and two electrode covers 4 that are respectively externally provided with a dummy pin 45 and a through hole 40, such that the glass tube 1 and the LED chip circuit board 3 can be easily assembled to the electrode covers 4 simply by extending the two contact pins 30 of the LED chip circuit board 3 through the electrode covers 4 via the two through holes 40 without the need of welding. With these arrangements, the LED tube lamp can be conveniently manufactured with simplified procedures to enable largely reduced manufacturing time and labor costs and increased yields. Further, since the LED driving circuit is arranged outside the electrode covers 4, the electrode covers 4 can be made thinner and shorter to shield less area of the glass tube 1 and accordingly, enable increased illumination area. Moreover, since the fully assembled LED tube lamp structure according to the present invention includes an outer portion completely formed of the glass tube 1, which not only has a light transmittance much higher than that of the conventional frosted plastic lamp shade to provide higher brightness, but also provides very good heat transfer effect. In brief, the easily assembled LED tube lamp structure of the present invention is advantageous in that the heat-dissipation metal base 2 can also have a largely reduced volume for mounting inside the glass tube 1, and that the LED tube lamp structure can be conveniently manufactured with fewer materials at lowered costs.

The present invention is also characterized in that the heat-dissipation metal base 2 include a slightly arched middle section 21 extended between two end portions 22, and therefore has a predetermined curvature. In assembling the LED tube lamp structure of the present invention, the slightly curved heat-dissipation metal base 2 can be straightened by applying a minor force to the two end portions 22, and the arched back 24 can be bonded to the inner surface 12 of the glass tube 1 via the thermal adhesive 20. When the two end portions 22 of the heat-dissipation metal base 2 are inserted into the insertion sections 41 in the two electrode covers 4, the heat-dissipation metal base 2 is well held in place while the horizontal wing portions 412 of the insertion sections 41 enable the heat-dissipation metal base 2 to generate an upward tension. With this effective design, it is ensured an LED tube lamp of any length can always have a heat-dissipation metal base 2 tightly adhered to the inner surface of the glass tube 1 without becoming dropped, deformed or separated from the glass tube 1 even when the LED tube lamp is lightened and produces heat. This is because the heat-dissipation metal base 2 is in tight contact with the inner surface of the glass tube 1 under the upward tension, allowing the heat produced by the LED tube lamp to be effectively transferred from the heat-dissipation metal base 2 to the whole glass tube 1 and be uniformly dissipated from the glass tube 1 into ambient air. In this manner, the LED chip circuit board 3 inside the glass tube 1 can maintain normal operation and the LED tube lamp can have effectively extended service life.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An easily assembled LED tube lamp structure, comprising:
a glass tube being a heat-transferring and light-pervious hollow cylindrical member having two open ends;
a heat-dissipation metal base being a long strip with a predetermined curvature, and having a front side formed into a receiving seat and a rear side attached to an inner surface of the glass tube via a thermal adhesive;
an LED chip circuit board being fitted in the receiving seat on the front side of the heat-dissipation metal base, and being provided at each of two opposite ends with a substantially axially outward extended contact pin; and
two electrode covers being fitted on the two open ends of the glass tube, and being respectively externally provided with a fixing dummy pin and a through hole and internally provided with an insertion section; the contact pins on the two ends of the LED chip circuit board being outward extended through the two through holes of the electrode covers, and the heat-dissipation metal base having two end portions inserted into the two insertion sections to thereby be fixedly held in place and generate an upward tension;
wherein, since the glass tube, the metal heat-dissipation metal base and the LED chip circuit board are assembled to the electrode covers simply by extending the two contact pins of the LED chip circuit board through the electrode covers via the two through holes without the need of welding, the LED tube lamp can be manufactured with simplified procedures to enable increased yields; and wherein, since the heat-dissipation metal base is tightly attached to the inner surface of the glass tube via the thermal adhesive and under the upward tension without the risk of becoming dropped, deformed or separated from the glass tube, heat produced by the lightened LED tube lamp can be effectively transferred from the heat-dissipation metal base to the whole glass tube and uniformly dissipated from the glass tube into ambient air.

2. The easily assembled LED tube lamp structure as claimed in claim 1, wherein the heat-dissipation metal base has a substantially arcuate cross section, giving the rear side of the heat-dissipation metal base a slightly tensioned arched back; and wherein the receiving seat on the front side of the heat-dissipation metal base is in the form of an inward recessed channel.

3. The easily assembled LED tube lamp structure as claimed in claim 2, wherein the electrode covers are configured as two caps respectively defining an internal space, in which there is provided an open-topped round bracket that has two facing ends formed into two horizontal wing portions; and the open-topped round bracket together with the two horizontal wing portions constituting the insertion section.

4. The easily assembled LED tube lamp structure as claimed in claim 3, wherein the heat-dissipation metal base is an elongated aluminum extrusion strip.
